(19) United States
(12) Patent Application Publication
(10) Pub. No.: US 2019/0081299 A1
(43) Pub. Date: Mar. 14, 2019

(54) Battery Case with Shock-Absorbing Impact Geometry

(71) Applicant: Samsonite IP Holdings S.àr.l., Luxembourg (LU)

(72) Inventors: Randy Yang Chiang, San Mateo, CA (US); Bryan Lee Hynecek, Redwood City, CA (US); Ivan Chen, Mountain View, CA (US); Eric Frasch, San Francisco, CA (US); Darrick Del Moral, San Bruno, CA (US)

(73) Assignee: Samsonite IP Holdings S.ar.l., Luxembourg (LU)

(21) Appl. No.: 15/699,621

(22) Filed: Sep. 8, 2017

(51) Int. Cl. H01M 2/10; A45C 11/00; A45C 15/00

(52) U.S. Cl. CPC H01M 2/1094; A45C 11/00; H02J 7/0047; H01M 2/1066; A45C 2011/002; A45C 15/00

(57) ABSTRACT

A case (1) for a mobile device, including a rear side, an electrical power storage device (28), and an electrical connector (18). The rear side (6) has an upper portion (6a), a lower portion (6b), and a hinge (24) arranged between the upper and lower portions (6a,6b). The hinge (24) is configured to allow the upper portion (6a) to rotate with respect to the lower portion (6b) so that a rear surface of the upper portion (6a) and a rear surface of the lower portion (6b) form an angle of less than 180°. The electrical connector (18) is electrically connected with the power storage device (28), and is configured to connect with the mobile device when the mobile device is arranged within the case (1) to electrically connect the power storage (28) device with the mobile device (1).

### FIELD OF THE INVENTION

The present invention relates to a case with an integrated battery for a mobile device. The case includes shock-absorbing impact geometry in the form of triangular ridges that protrude from the inner surface of the sides of the case.

Cases for mobile devices have been designed to provide at least some protection from impact events, such as when the device is dropped, hit, or otherwise struck. In order to provide such protection, materials are often employed which noticeably increase the thickness and weight of the case, and thus impact the portability and ease of use of the resultant protected device. One way to improve the impact protection of a case is to increase the amount of material in the case that provides the impact protection. But this increases the cost of the case in terms of materials, and further increases the size and weight of the case, which is undesirable to users.

US 2015/0195929 discloses a case for a mobile device, the case includes a band arranged to surround the edge of the device. The band includes a layer of flexible polymer. A separate layer of a damping material that is softer than the flexible polymer is provided within the flexible polymer layer. The damping material has a plurality of protrusions projecting inwardly from the inner periphery of the band to engage with the device. But these protrusions are thin semicircular protrusions. While these protrusion do absorb some shock, they are imperfect in that, as the protrusions deform/compress between the mobile device and the rest of the case, the surface area of the protrusions that contact the case to absorb the impact increases very quickly.

Cases for mobile devices have been also been designed to provide an additional power source to run or recharge a mobile device arranged in the case. One way to do this is to provide a case with an integrated battery that provides power to a mobile device when arranged in the case. But this increases the further increases the size and weight of the case, which is undesirable to users. It also presents a problem of how to get the mobile device into and out of the case without damaging any of the electrical connections in the case or the mobile device.

U.S. Pat. No. 9,077,013 discloses a case for a mobile device, the case includes a battery pack integrated into the case. Different embodiments of this case provide different ways of getting a mobile device into and out of the case. In one embodiment, shown in FIGS. 1-5, the mobile device is slid into the case from the top of the case. The is achieved by a case that has no upper side, with left and right sides that do not extend fully to the upper portion of the case. This leaves a large portion of the sides any mobile device arranged in the case exposed to potential damage from a drop or fall. Another embodiment shown in FIGS. 6-9 has a large gap in the upper side of the case that extends down roughly half of the left and right sides of the case. This also exposes a large portion of the sides of a mobile device to potential damage. In yet another embodiment, shown in FIGS. 10-18B, the upper and lower portions of the case slide apart to allow a phone to be placed in the case, and then slide back together to close the case around the phone. But this requires the case to consist of multiple parts with moving mechanisms to allow parts of the case to move away from each other, creating a more expensive and complicated case that becomes unusable if the sliding mechanism were to fail.

### SUMMARY OF THE INVENTION

As such, it is desirable to provide a new case for a protective device which can provide additional power as well as increased shock/impact protection to a mobile device without adding significantly to the cost, size, or weight of the case.

According to the present invention there is therefore provided a case for a mobile device as described by way of example below and in the accompanying claims.

In one embodiment of the invention there is provided a case (1) for a mobile device, including a rear side, an electrical power storage device (28), and an electrical connector (18). The rear side (6) has an upper portion (6a), a lower portion (6b), and a hinge (24) arranged between the upper and lower portions (6a,6b). The hinge (24) is configured to allow the upper portion (6a) to rotate with respect to the lower portion (6b) so that a rear surface of the upper portion (6a) and a rear surface of the lower portion (6b) form an angle of less than 180°. The electrical connector (18) is electrically connected with the power storage device (28), and is configured to connect with the mobile device when the mobile device is arranged within the case (1) to electrically connect the power storage (28) device with the mobile device (1).

In another embodiment, the hinge (24) is configured to allow the upper portion (6a) to rotate with respect to the lower portion (6b) so that a rear surface of the upper portion (6a) and a rear surface of the lower portion (6b) form an angle of less than 150°.

In yet another embodiment, the hinge (24) is configured to allow the upper portion (6a) to rotate with respect to the lower portion (6b) so that a rear surface of the upper portion (6a) and a rear surface of the lower portion (6b) form an angle of less than 135°.

In a further embodiment, the hinge (24) is configured to allow the upper portion (6a) to rotate with respect to the lower portion (6b) so that a rear surface of the upper portion (6a) and a rear surface of the lower portion (6b) form an angle of less than 120°.

In yet a further embodiment, the hinge (24) is configured to allow the upper portion (6a) to rotate with respect to the lower portion (6b) so that a rear surface of the upper portion (6a) and a rear surface of the lower portion (6b) form an angle of less than 105°.

In another embodiment, the hinge (24) is configured to allow the upper portion (6a) to rotate with respect to the lower portion (6b) so that a rear surface of the upper portion (6a) and a rear surface of the lower portion (6b) form an angle of less than 90°.

In yet another embodiment, the hinge (24) is configured to allow the upper portion (6a) to rotate with respect to the lower portion (6b) so that a rear surface of the upper portion (6a) and a rear surface of the lower portion (6b) form an angle of less than 75°.

In a further embodiment, the hinge (24) is configured to allow the upper portion (6a) to rotate with respect to the lower portion (6b) so that a rear surface of the upper portion (6a) and a rear surface of the lower portion (6b) form an angle of less than 60°.

In yet a further embodiment, the hinge (24) is configured to allow the upper portion (6a) to rotate with respect to the lower portion (6b) so that a rear surface of the upper portion (6a) and a rear surface of the lower portion (6b) form an angle of less than 45°.

In another embodiment, the hinge (24) is configured to allow the upper portion (6a) to rotate with respect to the lower portion (6b) so that a rear surface of the upper portion (6a) and a rear surface of the lower portion (6b) form an angle of less than 30°.

In yet another embodiment, the hinge (24) is configured to allow the upper portion (6a) to rotate with respect to the lower portion (6b) so that a rear surface of the upper portion (6a) and a rear surface of the lower portion (6b) form an angle of less than 15°.

In a further embodiment, the upper portion (6a) of the rear side (6) is formed by a first layer (2a) including a first material, the first layer having a first-layer front-side surface and a first-layer rear-side surface opposite to the first-layer front-side surface. The lower portion (6b) of the rear side (6) is formed by a second layer (2b) including a second material, the second layer having a second-layer front-side surface and a second-layer rear-side surface opposite to the second-layer front-side surface. The hinge (24) of the rear side (6) is formed by a third layer (3) including a third material, the third layer (3) having a third-layer front-side surface and a third-layer rear-side surface opposite to the third-layer front-side surface. A first portion of the third-layer rear-side surface is attached to a portion of the first-layer front-side surface. A second portion of the third-layer rear-side surface is attached to a portion of the second-layer front-side surface.

In yet a further embodiment, the third material is different from both the first and second materials.

In another embodiment, the third material comprises an elastomeric material, the elastomeric material forming at least part of the hinge (24).

In yet another embodiment, the first material is the same as the second material.

In a further embodiment, the first material is different from the second material.

In yet a further embodiment, each of the first and second materials include at least one material selected from the group consisting of hardened plastic materials, rigid or semi-rigid plastic materials, rigid rubber materials, polycarbonate materials, metals, alloys, para-aramid materials, wood, glass, mirror, quartz, and combinations thereof. The third material includes at least one material selected from the group consisting of thermoplastic elastomers (“TPEs”), thermoplastic polyurethane (“TPU”), silicone, rubber, and combinations thereof.

In another embodiment, the third layer (3) is removably connected to at least one of the second and third layers (2a,2b).

In yet another embodiment, the third layer (3) is removably connected to both of the second and third layers (2a,2b).

In a further embodiment, the third layer (3) is permanently connected to at least one of the second and third layers (2a,2b).

In yet a further embodiment, the third layer (3) is permanently connected to both of the second and third layers (2a,2b).

In another embodiment, the case (1) further includes a mount (30) that connects to the rear side (6) and mounts the electrical power storage device (28) between the mount (30) and the rear side (6).

In yet another embodiment, the electrical connector (18) is arranged in the mount (30) so as to be closer to a front side (30a) of the mount (30) than to a rear side of the mount (30).

In a further embodiment, the mount (30) is removably connected to the rear side (6).

In yet a further embodiment, the mount (30) is permanently connected to the rear side (6).

In another embodiment, the electrical power storage device (28) comprises a battery.

In yet another embodiment, the case (1) further includes a first side (9), a second side (10), a third side (7), and a fourth side (8). The first side (9) extends from the rear side (6) and has an inside surface and an outside surface opposite to the inside surface. The second side (10) extends from the rear side (6) and has an inside surface and an outside surface opposite to the inside surface. The third side (7) extends from the rear side (6) and has an inside surface and an outside surface opposite to the inside surface. The fourth side (8) extends from the rear side (6) and has an inside surface and an outside surface opposite to the inside surface. The inside surface of the first side (9) faces toward the inside surface of the second side (10). The inside surface of the third side (7) faces toward the inside surface of the fourth side (8). The first and second sides (9,10) are arranged between the third and fourth sides (7,8), and the third and fourth sides (7,8) are arranged between the first and second sides (9,10), so that the first, second, third, and fourth sides (9,10,7,8) form at least part of a frame configured to surround a periphery of the mobile device when the mobile device is arranged inside the case (1). At least one of the inside surfaces of the first, second, third, and fourth sides (9,10,7,8) includes triangular protrusions (4) that have a triangular cross section and extend toward the inside of the case, so that an apex of each of the triangular protrusions (4) contacts the mobile device when it is arranged inside the case.

In a further embodiment, at least two of the inside surfaces of the first, second, third, and fourth sides (9,10,7,8) include the triangular protrusions (4).

In yet a further embodiment, at least three of the inside surfaces of the first, second, third, and fourth sides (9,10,7,8) include the triangular protrusions (4).

In another embodiment, the inside surface of the first side (9) is connected to the inside surface of the third side (7) to form a first corner, the first corner having an inside surface that includes at least one of the triangular protrusions (4).

In yet another embodiment, the inside surface of the second side (10) is connected to the inside surface of the third side (7) to form a second corner, the second corner having an inside surface that includes at least one of the triangular protrusions (4).

In a further embodiment, the inside surface of the second side (10) is connected to the inside surface of the fourth side (8) to form a third corner, the third corner having an inside surface that includes at least one of the triangular protrusions (4).

In yet a further embodiment, the rear side (6) and the first, second, third, and fourth sides (9,10,7,8) form a pocket configured to hold the mobile device.

It is noted that the features of the above-described embodiments are not exclusive to each other, and that any one of the above embodiments/features can be combined with one or more of the other embodiments/features to arrive at further embodiments.

The inventive case can be designed to fit a variety of mobile devices—such as smartphones and other portable electronic devices.

### BRIEF DESCRIPTION OF THE DRAWINGS

FIG. 1 is an upper side view of the case in accordance with an embodiment of the invention.

FIG. 2 is a rear view of the case in accordance with an embodiment of the invention.

FIG. 3 is a right side view of the case in accordance with an embodiment of the invention.

FIG. 4 is a left side view of the case in accordance with an embodiment of the invention.

FIG. 5 is a lower side view of the case in accordance with an embodiment of the invention.

FIG. 6 is a front view of the case in accordance with an embodiment of the invention.

FIG. 7 is a front-right perspective view of the case in accordance with an embodiment of the invention showing an enlarged view of a portion of the case.

FIG. 8 is a right side view of the case in accordance with an embodiment of the invention, showing how an upper portion of the case includes hinge 24 to allow the upper portion to bend back so that a mobile device can be inserted into the case.

FIG. 9 shows a close-up view of the shock-absorbing triangular ridges 4 that protrude from the inner surface of the sides of the case, and the troughs 5 located between the triangular ridges 4.

FIG. 10 shows a close-up cut-away view of the case 1 with a mobile device arranged therein prior to impact.

FIG. 11 shows a close-up cut-away view of the case 1 with a mobile device arranged therein during impact.

FIG. 12 is an exploded view of the case in accordance with an embodiment of the invention.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments. It is noted that any numerical ranges disclosed herein are included to individually disclose every sub-range and number, both whole integer and partial fraction, within the disclosed range. For example, a disclosed range of 1-100 is intended to individually disclose 20-90, 40-80, 30.5-50.2, 20, 67.3, 84.512924, and every other range and number that falls within the recited range.

A case according to an embodiment of the invention can be arrived at by providing shock-absorbing impact geometry to the interior of the case in the form of triangular ridges that protrude from the inner surface of the sides of the case. The narrow tops of the ridges contact the surface of the device. When force is applied between the outside of the case and the device, such as during an impact event, the force causes the triangular ridges to deform against the surface of the device. As force increase, further deformation of the ridges increases the volume of deformed material. This configuration allows the case to absorb impact and reduce the forces communicated to a device within the case in the event the device and case are dropped on a hard surface.

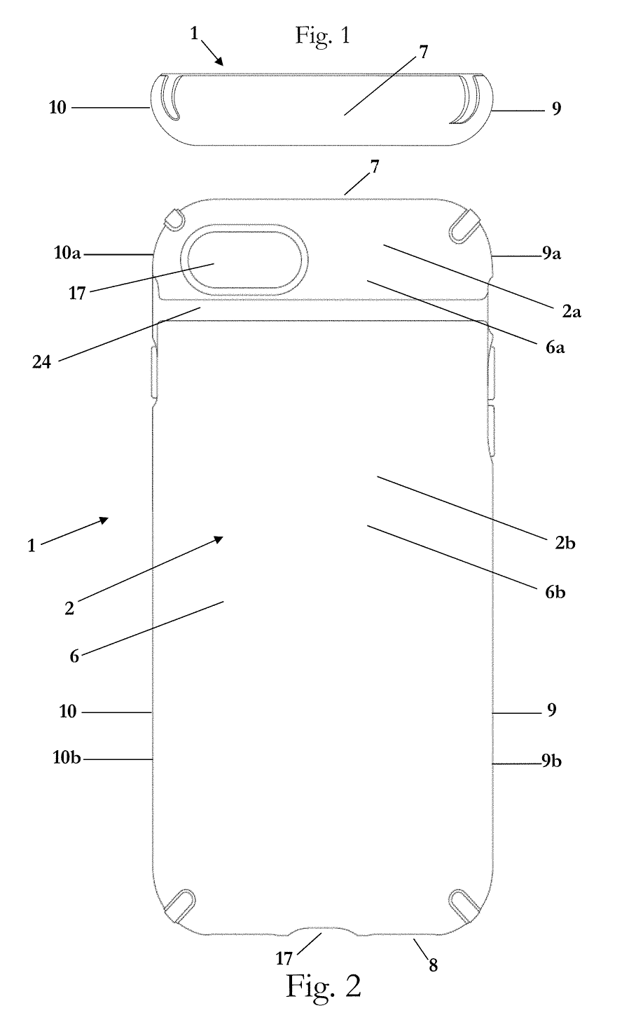

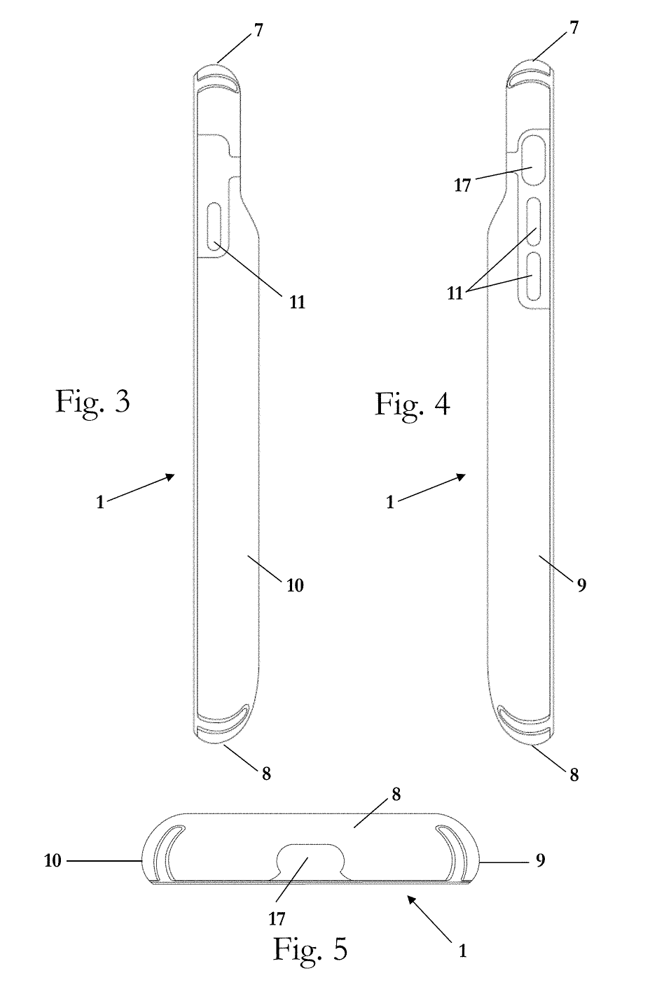

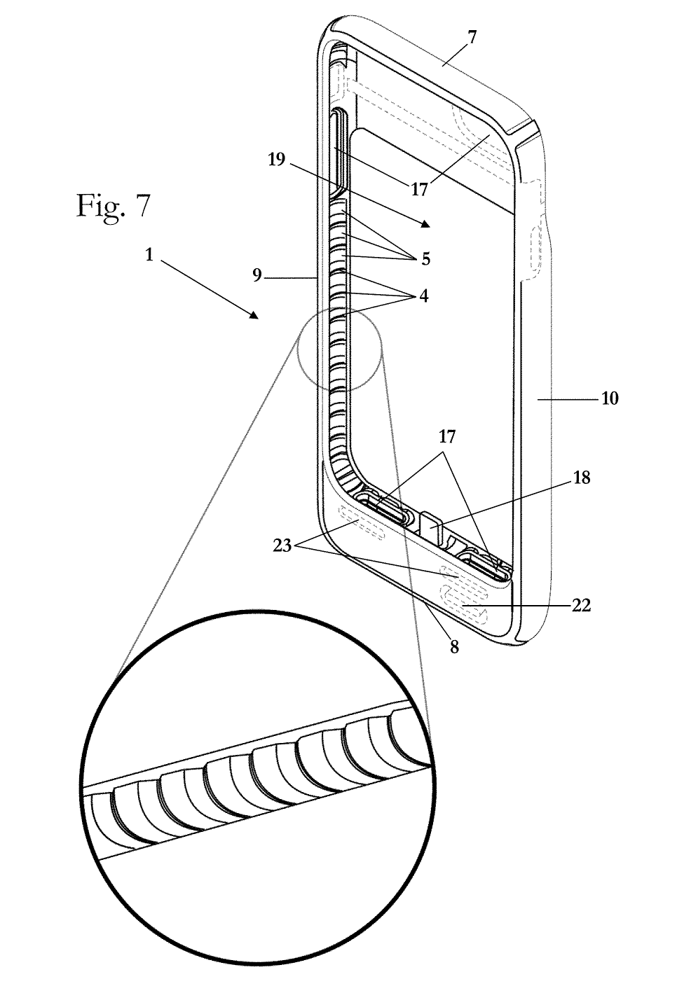

FIGS. 1-7 show an upper side view, a rear view, a right side, a left side view, a lower side view, a front view, a front view, and a front-right perspective view, respectively, of the case in accordance with an embodiment of the invention. The case 1 includes a first layer or shell 2 and a second layer 3. The first layer or shell 2 has an upper-shell portion 2a and a lower-shell portion 2b. The upper-shell portion 2a and lower-shell portion 2b are separated by a hinge 24. Each of the upper-shell portion 2a and lower-shell portion 2b includes a rear side having an inside surface (not shown) and an outside surface 6a,6b opposite to the inside surface, with the outside surfaces 6a,6b and the hinge 24 forming an outside surface 6 of the case 1. An upper side 7, a lower side 8, a left side 9 (formed by left sides 9a,9b), and a right side 10 (formed by right sides 10a,10b) extend from the outside surface 6 of the rear side toward a front of the case 1 so as to form a pocket or recess in which the second layer 3 will be—and eventually a mobile device can be—arranged. The second layer 3 also includes a corresponding rear side having an inside surface 21, as well as one or more of corresponding upper, lower, left, and right sides. A pocket or recess 19 may be formed in second layer 3 for receiving the mobile device.

In one embodiment, the rear sides of the first layer 2 and second layer 3 overlay each other. The rear sides of the first layer or shell 2 and second layer 3 are also preferably substantially coextensive with each other so that the rear side of each layer covers at least 50% of the surface area of the rear side of the other layer. It is also preferable that the respective upper sides, lower sides, left sides, and right sides of the first layer 2 and second layer 3 are substantially coextensive with each other so that the respective upper sides, lower sides, left sides, and right sides of each layer covers at least 50% of the surface area of the corresponding side of the other layer. Additionally, it is preferable that the rear of the case (formed by the rear sides of the first layer 2 and second layer 3) is configured to cover at least 90%, if not all, of the rear of a mobile device when the mobile device is arranged within the case.

According to another embodiment, the respective upper sides, lower sides, left sides, and right sides of the first layer 2 and second layer 3 are only partially coextensive with each other so that the respective upper sides, lower sides, left sides, and right sides of the first layer 2 cover only a portion of the respective sides of the second layer 3.

The first layer or shell 2 is preferably formed from a rigid or hard material to create a rigid/hard outer shell which provides at least some impact protection as well as protection from being punctured by impacts with sharp objects. Examples of suitable hard/rigid materials include hardened plastic material, a rigid or semi-rigid plastic material, a rigid/hard rubber material, a polycarbonate material, a metal, an alloy, a para-aramid material, wood, glass, mirror, quartz, and any combination thereof, and may be any color or texture. Preferred materials include thermosetting plastics with a hard durometer having shore 30D to shore 100D, polycarbonate, poly(methyl methacrylate) (“PMMA”), metals, acrylonitrile butadiene styrene (“ABS”), PMMA, polyethylene terephthalate (“PET”), high durometer thermoplastic elastomers (“TPEs”) and thermoplastic polyurethanes (“TPUs”) having shore 30D to shore 100D, and any combination thereof. The hard protective exterior shell may be designed to mimic the finish of existing mobile devices, such as phones, MP3/4 players, tablets, laptops, and other mobile electronic devices. Many users like the feel of the original phone and would like to maintain that feel but still want protection for their device. The hard protective exterior shell of the present invention has a low coefficient of friction. This allows the device to be slipped in and out of pockets and bags easily with little resistance and without becoming attached to clothing or fabric materials—a major complaint from users when an elastomeric material is used for the outside of cases.

The outside surface of the first layer or shell 2 may be provided with a scratch resistant UV hardcoat, which resists scratches and prevents discoloration of the case due to UV exposure.

The second layer 3 is preferably formed from a soft elastomeric material which provides at least some shock protection from impact events such as drops or falls. Examples of suitable materials include thermoplastic elastomers (“TPEs”), thermoplastic polyurethane (“TPU”), polyolefins, silicone, rubber, and any combination thereof. The second layer 3 may also be designed so that there are no gaps between the rear of the mobile device and the inside surface 21 of the rear side of the case. This enables the case to have a very solid connection to the phone. The second layer 3 may additionally be formed with a lip or rim 20 so as to secure and retain the mobile device within the case 1. The elastomeric layer 3 also can be formed to have portions 11 designed to cover buttons on a mobile device. This allows a user to simply press the exposed portion 11 of the inner elastomeric layer 3 corresponding to the desired input of the mobile device.

The second layer 3 may also, or alternatively, be formed from a non-Newtonian dilatant material. The dilatant material is soft and flexible when at rest, but stiffens and/or hardens upon impact. In this way, the dilatant material is able to provide both impact protection by dispersing the force of an impact event along the surface of the second layer 3, and shock protection by absorbing some of the shock force of the impact event. This dual quality (i.e., absorbing and diffusing impact or impact forces) of the dilatant material allows for less material to be used to make the case—allowing for a thinner, lighter, and less bulky case which increases the portability of the protected mobile device—while still providing increased impact and shock protection to the mobile device encased therein.

Examples of suitable dilatant materials for the second layer 3 include materials made by D3O® (such as D3O® ST, D3O® XT, D3O® Shock+, and D3O® Aero), PORON® XRD™ made by Rogers Corporation, and ARTi-LAGE™ artificial cartilage foam made by ARTiLAGE™. Impact absorbing materials (such as foams) which have dilatant properties are especially preferred.

The dilatant material may have a hardness of at least 20 Shore OO, or may have a hardness of at least 5 Shore O. Preferably the hardness is at least 30 Shore OO, at least 50 Shore OO, at least 60 Shore OO, or at least 70 Shore 00. More preferably the hardness is in a range of 20-90 Shore OO, or in a range of 5-61 Shore O. More preferably still, the hardness is in a range of 30-80 Shore OO, or in a range of 5-40 Shore O. Even more preferably, the hardness is in a range of 40-70 Shore OO.

Preferably the second layer 3 has a hardness in the range of from 60-85 Shore A. If the second layer 3 is clear, its preferred hardness is 75-85 Shore A. If the second layer 3 is opaque, its preferred hardness is 60-75 Shore A.

Each of the first layer 2 and rear side of the second layer 3 is 0.5-4.0 mm thick. Preferably one or more of the layers is 0.6-3.0 mm thick. More preferably, one or more of the layers is 0.8-2.0 mm thick. Even more preferably, one or more of the layers is 0.9-1.3 mm thick.

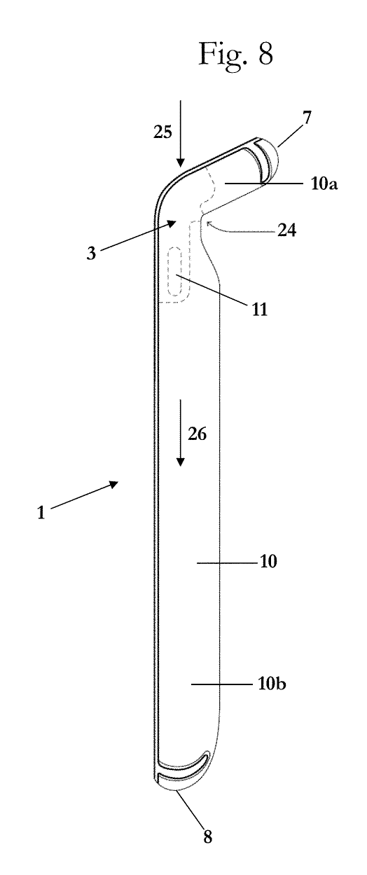

As shown in FIG. 8, the hinge 24 allows the upper-shell portion 2a to rotate around a pivot compared to the lower-shell portion 2b. This allows a mobile device to be slid into the case 1 in a direction 25 parallel to an upper-to-lower direction 26 of the case 1, so that an electrical connector 18 of the case 1 can be inserted straightly into the female power connector of the mobile device. Such a straight insertion, as opposed to an insertion where the mobile device is inserted at an angled direction with respect to upper-to-lower direction 26 of the case 1, prevents potential damage to either the electrical connector 18 of the case 1 of the female power connector of the mobile device. After the mobile device is inserted into the case 1, the upper-shell portion 2a is then rotated back so that it is straight and parallel with the lower-shell portion 2b. This configuration allows the case to completely cover the rear, upper, lower, left, and right sides of the mobile device—providing complete protection for all five sides. Additionally, the lip or rim 20 of the second layer 3 can be configured to extend away from a screen of a mobile device inserted into the case, thereby providing at least some protection for the screen in the event of a drop or fall.

In one embodiment, the hinge 24 is formed by the second layer 3, which is made from a flexible elastomeric material. This simplifies the manufacturing process, and removes a potential point of failure compared to a mechanical multi-part hinge made from rigid components, such as the type typically found on doors or the type depicted in FIGS. 18a-18b of U.S. Pat. No. 9,077,013 (discussed above).

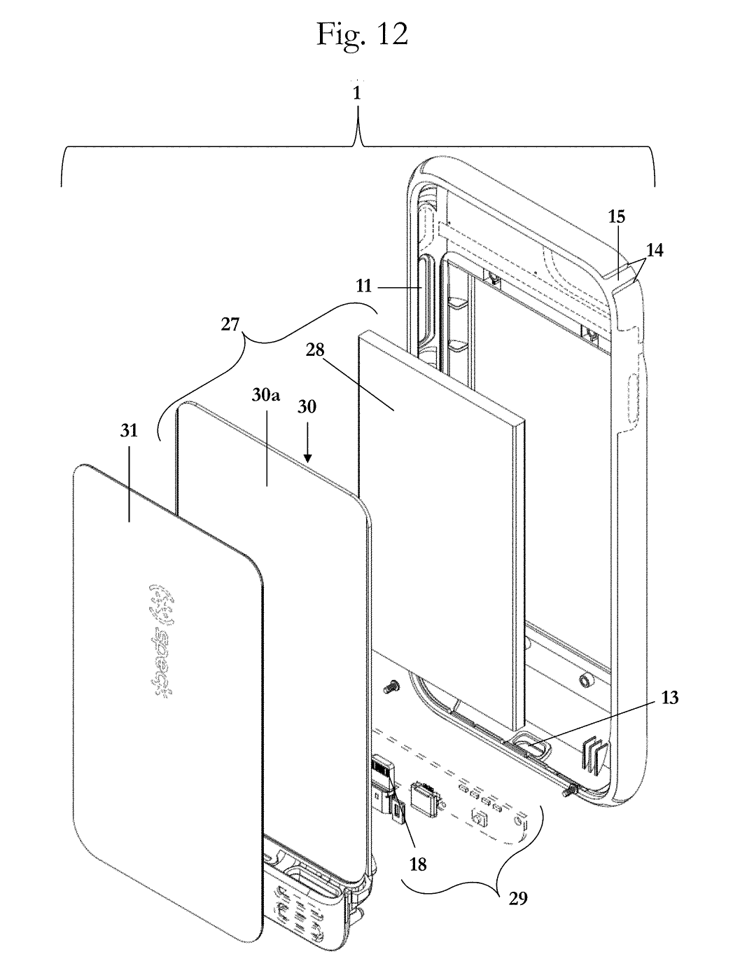

As shown in FIG. 12, the case includes a power supply portion 27, which has an electrical power storage device 28 (e.g., a battery), electrical connections 29 (including electrical connector 18), and a mount 30. The electrical connections 29 connect the battery 28 to the power connector of a mobile device to enable the battery 28 to supply power to the mobile device when it is arranged in the case 1. The mount 30 mounts the battery 28 electrical connections 29 to case 1 in the pocket or recess 19. A cover layer or plate 31 can be arranged to cover at least a portion of the inside surface 30a of the mount 30.

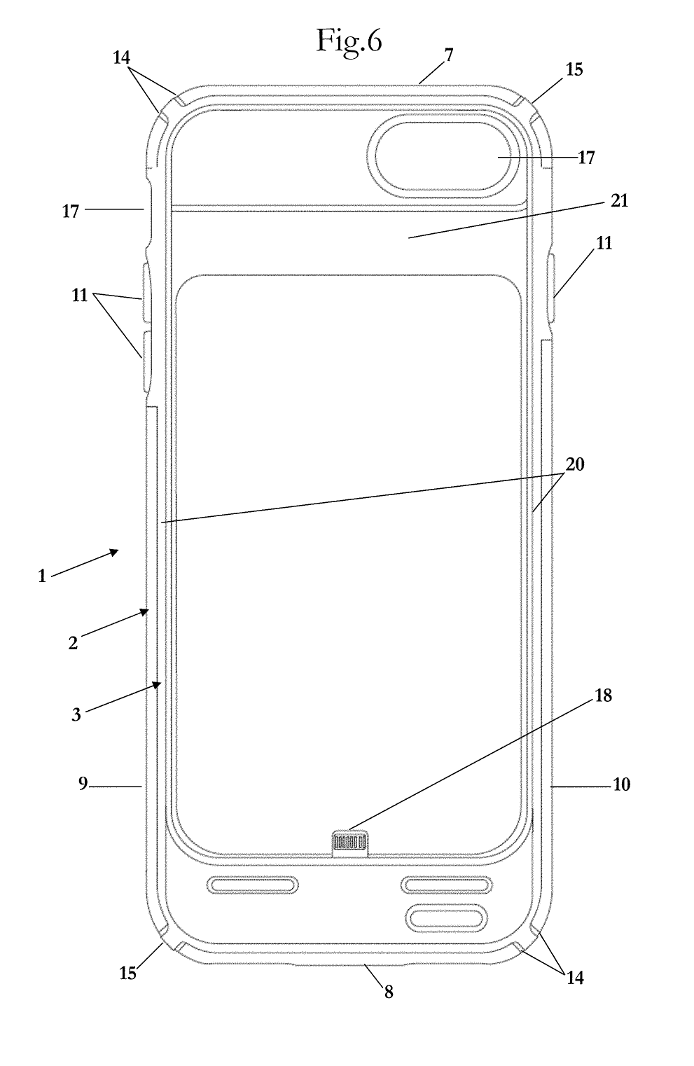

The case can also include a power button or switch 22 and one or more indicator lights 23. Preferably, one or more of the power button or switch 22 and indicator lights 23 are part of and/or integrated into the mount 30. Also preferably, one or more of the power button or switch 22 and indicator lights 23 are arranged on the front of the case 1 as shown in FIG. 6. This provides users with an easier and more intuitive operation compared to arranged the power button 22 and lights 23 on the sides of the case, the rear of the case, or inside the case.

The power button or switch 22 is placed in an on position to complete an electrical circuit between the battery 28 and a mobile device arranged in the case 1 to supply power from the battery 28 to the mobile device. The power button or switch 22 is placed in an off position to break the electrical circuit between the battery 28 and a mobile device arranged in the case 1 to prevent power from being supplied from the battery 28 to the mobile device even when a mobile device is arranged in the case and connected with the electrical connector 18.

The indicator lights 23 may be light emitting diodes (“LEDs”) that light to indicate when the power button or switch 22 is placed in the on position and an electrical connection is established between the battery 28 and the mobile device. The LED indicator lights 23 may also indicate when the battery 28 of the case 1 is in a charging state or in a fully charged state, preferably by lighting up in two or more different colors. In another embodiment, the LED indicator lights 23 indicate when the battery 28 of the case 1 is in a charging state or in a fully charged state by flashing or solidly lit. In yet another embodiment, multiple flashing patterns of the LED indicator lights 23 indicate respective multiple charging states—such as charging at a low battery state of 0% to 35% charged, charging at a medium battery state of 35% to 65% charged, and charging at a high battery state of 65% to less than 100% charged.

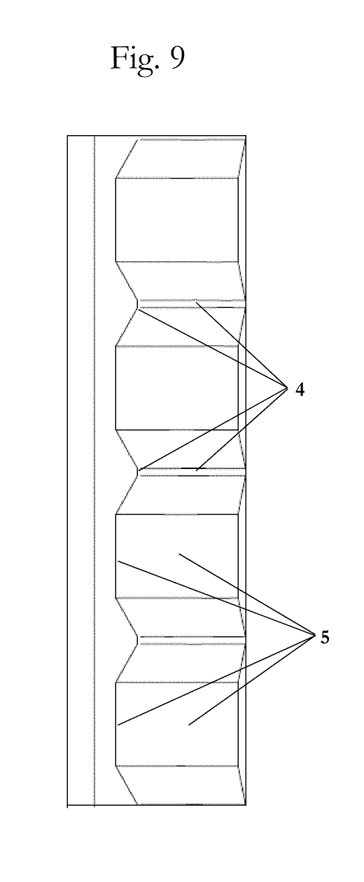

In one embodiment, the case 1 includes shock-absorbing impact geometry in the form of triangular ridges 4 that protrude from the inner surface of one or more sides of the case 1. Between each triangular ridge 4 is a trough 5. The triangular ridges 4 are formed by the second layer 3, and so are made of the elastomeric or non-Newtonian dilatant material of the second layer 3. FIG. 9 shows a close-up view of a section of the second layer 3 with the triangular ridges 4 and the troughs 5. This unique series of triangular ridges 4 act as a shock barrier and dissipate impact forces.

The triangular shape of the ridges 4 absorbs shock. The triangular ridges deform when force is applied between the surface of the device and the hard layer 3. The triangular shaped ridges deform in a different manner than semicircular or rectilinear protrusions, which may provide improved absorption of energy and less communication of forces to the device due to impact than protrusions of other shapes. In particular, as the triangular ridges 4 of the current invention compress and deform between the mobile device and the case upon impact, the surface area of the triangular ridges 4 gradually increase.

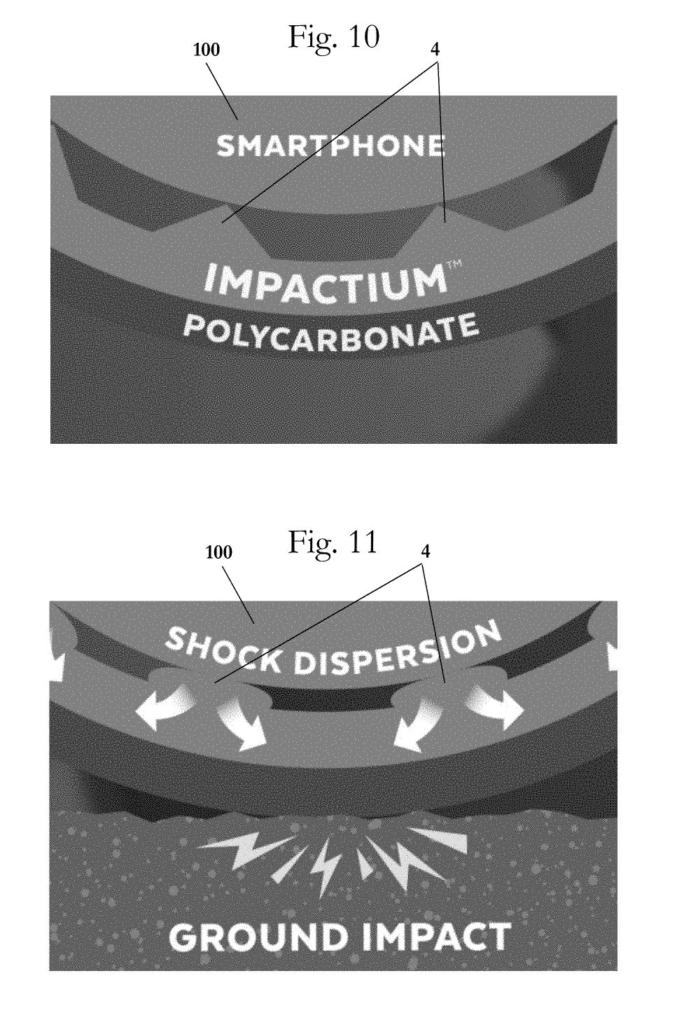

As shown in FIG. 10, the triangular ridges 4 only slightly contact the mobile device 100 arranged in the case 1. During impact, as shown in FIG. 11, the triangular ridges 4 compress against the mobile device 100, gradually changing shape (in cross section) from a triangular shape to a trapezoidal shape, and eventually to a rectilinear shape. This gradual change in cross-sectional shape of the triangular ridges 4 means that the shock-absorbing capability of the ridges 4 increases non-linearly—first due to the properties of the ridge material itself as it compresses and absorbs shock (i.e., the same way a solid and smooth layer of that material would absorb shock upon compression), and second due to the change in cross-sectional shape independent of the ridge material. The gradual change in cross-sectional shape of the triangular ridges 4 provides a slower decrease in velocity (i.e., a lower deceleration) of the mobile device during impact as compared to a semi-circular shape (which quickly becomes rectilinear) and a rectilinear shape (which is doesn't change its type of shape and merely compresses). Such a reduced deceleration results in less shock being absorbed by the mobile device, as it is instead absorbed by the gradual change in cross-sectional shape of the triangular ridges 4.

According to some embodiments the triangular ridges 4 protrude from the troughs 5 at a distance in the range of 0.300-4.00 mm, preferably 0.400-3.00 mm, more preferably 0.500-2.00 mm, and most preferably 0.600-1.50 mm. In one preferred embodiment, the distance between the surface of the troughs 5 and the tip of the triangular ridges 4 is around 1.00 mm.

The first layer 2 and second layer 3 may be co-molded/co-casted together or otherwise permanently affixed to each other, such as with an adhesive.

Alternatively, the first layer 2 and second layer 3 may be separable from one another as two distinct pieces. In such an instance, the two layers can be configured so that they mechanically engage with each other to form a unitary case. For example, the first layer 2 may be designed with slots or cutouts 14 into which corresponding ridges or ribs 15 of the second layer 3 engage (e.g., by snapping, pressure fitting, or any other suitable mechanical engagement). As another example opposite sides of the first layer 2 (e.g., upper side 7 and lower side 8, left side 9 and right side 10, or both) may be designed to snap onto and hold the second layer 3.

For example, one process for producing the case may be:

1. Mold the first layer 2; and

2. Place the first layer 2 into the overmold tool, and mold the second layer 3 onto the first layer 2.

Another example of a process for producing the case may be:

1. Mold the second layer 3; and

2. Place the second layer 3 into the overmold tool, and mold the first layer 2 onto the second layer 3.

Yet another example of a process for producing the case may be:

1. Mold the first layer 2;

2. Mold the second layer 3 (separately from, and before, after, or simultaneously with, the first layer 2); and

3. Join together the first layer 2 and the second layer 3.

It is noted that additional openings or cutouts 17 may be provided in at least a part of the case 1 so as to allow various buttons, ports, or features of a protected mobile device to be accessed without having to remove the mobile device from the case 1. For example openings or cutouts 17 may be provided to allow a user to engage a button of the protected mobile device either directly or via the cover portion 11 of the layer 3. As another example, cutouts 17 may be provided to create an opening in the case 1 though which a charging port, audio port, data port, or other electrical port of the mobile device may be accessed, either directly or via a pass-through connection. As yet another example, cutouts 17 may be provided to create an opening to expose a camera lens, audio speaker, microphone, or other feature of the device to be accessed or employed without removing the mobile device from the case 1.

The first layer 2 may also include relief slots or cutouts 14 in the hard material that allow the case to flex during installation and removal. Corresponding ridges or ribs 15 of the second layer 3 engage into the slots or cutouts 14. The second layer 3 includes the shock-absorbing impact geometry in the form of triangular ridges 4, as described above.

While the embodiments of the case 1 shown in the drawings are made from the two layers 2, 3, it can also be made of a single layer 3 that forms both the interior and exterior of the case 1.

It is noted that the terminology used above is for the purpose of reference only, and is not intended to be limiting. For example, terms such as “upper”, “lower”, “above”, “below”, “rightward”, “leftward”, “clockwise”, and “counterclockwise” refer to directions in the drawings to which reference is made. As another example, terms such as “inward” and “outward” may refer to directions toward and away from, respectively, the geometric center of the component described. As a further example, terms such as “front”, “rear”, “side”, “left side”, “right side”, “top”, “bottom”, “horizontal”, and “vertical” describe the orientation of portions of the component within a consistent but arbitrary frame of reference which is made clear by reference to the text and the associated drawings describing the component under discussion. Such terminology will include the words specifically mentioned above, derivatives thereof, and words of similar import.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

In addition, it is noted that citation or identification of any document in this application is not an admission that such document is available as prior art to the present invention.

1. A case for a mobile device, comprising:
a rear side comprising:
an upper portion; and
a lower portion; and
a hinge arranged between the upper and lower portions, the hinge being configured to allow the upper portion to rotate with respect to the lower portion so that a rear surface of the upper portion and a rear surface of the lower portion form an angle of less than 180°;
an electrical power storage device; and
an electrical connector that is electrically connected with the power storage device, and is configured to connect with the mobile device when the mobile device is arranged within the case to electrically connect the power storage device with the mobile device.

2. The case for a mobile device according to claim 1:
wherein the upper portion of the rear side is formed by a first layer comprising a first material, the first layer having a first-layer front-side surface and a first-layer rear-side surface opposite to the first-layer front-side surface;
wherein the lower portion of the rear side is formed by a second layer comprising a second material, the second layer having a second-layer front-side surface and a second-layer rear-side surface opposite to the second-layer front-side surface;
wherein the hinge of the rear side is formed by a third layer comprising a third material, the third layer having a third-layer front-side surface and a third-layer rear-side surface opposite to the third-layer front-side surface; and
wherein a first portion of the third-layer rear-side surface is attached to a portion of the first-layer front-side surface; and
wherein a second portion of the third-layer rear-side surface is attached to a portion of the second-layer front-side surface.

3. The case for a mobile device according to claim 2;
wherein the third material is different from both the first and second materials.

4. The case for a mobile device according to claim 2;
wherein the third material comprises an elastomeric material, the elastomeric material forming at least part of the hinge.

5. The case for a mobile device according to claim 2;
wherein the first material is the same as the second material.

6. The case for a mobile device according to claim 2;
wherein the first material is different from the second material.

7. The case for a mobile device according to claim 3;
wherein each of the first and second materials comprises at least one material selected from the group consisting of hardened plastic materials, rigid or semi-rigid plastic materials, rigid rubber materials, polycarbonate materials, metals, alloys, para-aramid materials, wood, glass, mirror, quartz, and combinations thereof; and
wherein the third material comprises at least one material selected from the group consisting of thermoplastic elastomers (“TPEs”), thermoplastic polyurethane (“TPU”), silicone, rubber, and combinations thereof.

8. The case for a mobile device according to claim 1;
wherein the third layer is removably connected to at least one of the second and third layers.

9. The case for a mobile device according to claim 8;
wherein the third layer is removably connected to both of the second and third layers.

10. The case for a mobile device according to claim 1;
wherein the third layer is permanently connected to at least one of the second and third layers.

11. The case for a mobile device according to claim 10;
wherein the third layer is permanently connected to both of the second and third layers.

12. The case for a mobile device according to claim 1, further comprising:
a mount that connects to the rear side and mounts the electrical power storage device between the mount and the rear side.

13. The case for a mobile device according to claim 12;
wherein the electrical connector s arranged in the mount so as to be closer to a front side of the mount than to a rear side of the mount.

14-15. (canceled)

16. The case for a mobile device according to claim 1;
wherein the electrical power storage device comprises a battery.

17. The case for a mobile device according to claim 1, further comprising:
a first side that extends from the rear side and has an inside surface and an outside surface opposite to the inside surface;
a second side that extends from the rear side and has an inside surface and an outside surface opposite to the inside surface;
a third side that extends from the rear side and has an inside surface and an outside surface opposite to the inside surface; and
a fourth side that extends from the rear side and has an inside surface and an outside surface opposite to the inside surface;
wherein the inside surface of the first side faces toward the inside surface of the second side;
wherein the inside surface of the third side faces toward the inside surface of the fourth side;
wherein the first and second sides are arranged between the third and fourth sides, and the third and fourth sides are arranged between the first and second sides, so that the first, second, third, and fourth sides form at least part of a frame configured to surround a periphery of the mobile device when the mobile device is arranged inside the case;
wherein at least one of the inside surfaces of the first, second, third, and fourth sides includes triangular protrusions that have a triangular cross section and extend toward the inside of the case, so that an apex of each of the triangular protrusions contacts the mobile device when it is arranged inside the case.

18. The case for a mobile device according to claim 17;
wherein at least two of the inside surfaces of the first, second, third, and fourth sides include the triangular protrusions.

19. (canceled)

20. The case for a mobile device according to claim 17;
wherein the inside surface of the first side is connected to the inside surface of the third side to form a first corner, the first corner having an inside surface that includes at least one of the triangular protrusions.

21. The case for a mobile device according to claim 20;
wherein the inside surface of the second side is connected to the inside surface of the third side to form a second corner, the second corner having an inside surface that includes at least one of the triangular protrusions.

22. The case for a mobile device according to claim 20;
wherein the inside surface of the second side is connected to the inside surface of the fourth side to form a third corner, the third corner having an inside surface that includes at least one of the triangular protrusions.

23. The case for a mobile device according to claim 17;
wherein the rear side and the first, second, third, and fourth sides form a pocket configured to hold the mobile device.
